(19) United States
(12) Patent Application Publication
(10) Pub. No.: US 2004/0223691 A1
(43) Pub. Date: Nov. 11, 2004

(54) Light pipe with directional side-light extraction

(76) Inventors: Roger F. Buelow II, Gates Mills, OH (US); John M. Davenport, Middleburg Heights, OH (US); Chris H. Jenson, Twinsburg, OH (US)

Correspondence Address: BRUZGA & ASSOCIATES, 11 BROADWAY, STE 400, NEW YORK, NY, 10004, US

(21) Appl. No.: 10/796,830

(22) Filed: Mar. 9, 2004

Related U.S. Application Data
(60) Provisional application No. 60/453,366, filed on Mar. 10, 2003.

(51) Int. Cl. G02B 6/16; G02B 6/26

(52) U.S. Cl. 385/31; 385/123

(57) ABSTRACT

A light pipe with directional side-light extraction comprises a light pipe and light-extraction structure applied to the light pipe over only a part of the cross-sectional perimeter of the light pipe and over an active section of the length of the light pipe in which directional side lighting is desired. The light-extraction structure comprises any of (i) material, other than a light-carrying portion of the light pipe or any fluoropolymer cladding on the light-carrying portion, including light-scattering material, (ii) surfaces treated to have light-scattering properties, and (iii) material with a reflective property. The foregoing light pipe eliminates the need for using a reflector, as with fluorescent lamps, by extracting the light only in the desired direction, towards a target area to be illuminated. Other embodiments of the invention promote uniformity in side light emission from a light pipe.

This application claims priority from U.S. Provisional Application No. 60/453,366 filed Mar. 10, 2003.

### FIELD OF THE INVENTION

The present invention relates to a light pipe used for side-light illumination purposes. More particularly, the invention relates to directional extraction of side light from a light pipe.

### BACKGROUND OF THE INVENTION

Light pipe is used in two main ways. In an end-light application, the light pipe is optimized to carry light along its length, and transmit it at the output face of the light pipe. In a side-light application, light is extracted out the side of the light pipe and provides illumination along its length. The present invention relates to applying light-extraction means over only a part of the circumference, or cross-sectional perimeter, a light pipe, less than 360 degrees, in order to extract light in a directional manner rather than over the full 360 degrees around the light pipe.

Often, light extracted from the side of a light pipe over the full 360 degrees around the light pipe is undesirable because a reflector would be needed to redirect a significant portion of the light towards the intended area to be illuminated. Some of the redirected light impinges on the light pipe and may be either absorbed into the light pipe so as to reduce side-light output, or is scattered into unintended directions. This is the same drawback associated with fluorescent lighting and results in an inefficient fixture for delivering light onto the target surface.

It would thus be desirable to eliminate the inefficient fixture and reflector combination for use with a light pipe by extracting the light only in the desired direction, towards the intended target to be illuminated.

It would be further desirable to obtain uniformity in light output along a section of light pipe in which side light is extracted.

### SUMMARY OF THE INVENTION

One embodiment of the invention provides a light pipe with directional side-light extraction comprising a light pipe and light-extraction means applied to the light pipe over only a part of the cross-sectional perimeter of the light pipe and over an active section of the length of the light pipe in which directional side lighting is desired. The light-extraction means comprises any of (i) material, other than a light-carrying portion of the light pipe or any fluoropolymer cladding on the light-carrying portion, including light-scattering material, (ii) surfaces treated to have light-scattering properties, and (iii) material with a reflective property.

The foregoing light pipe eliminates the need for using a reflector, as with fluorescent lamps, by extracting the light only in the desired direction, towards a target area to be illuminated.

Other embodiments of the invention promote uniformity in side light emission from a light pipe.

### BRIEF DESCRIPTION OF THE DRAWINGS

FIG. 1 is a simplified, schematic side view of a sidelight illumination system according to the present invention.

FIGS. 2a-2c are isometric views of light pipes, with FIGS. 2a and 2b showing prior art light pipes, while FIG. 3c shows a light pipe according to the present invention.

FIGS. 3-12 are side plan views of light pipes showing preferred geometries of light-extraction means, FIG. 5 being a cross sectional view taken at Lines 5-5 in FIG. 4.

FIG. 13a is a side plan view of a light pipe, and FIG. 13b is a cross-sectional view of the light pipe of FIG. 13a, in which a light-extraction means comprises light-reflective means.

FIGS. 14a and 14b are cross-sectional views of a light pipe with a core and clad and a light pipe with a core but no clad, respectively.

FIGS. 15 and 16 are simplified, isometric views, partially cutaway, of a co-extrusion die for inserting different types of light-extraction means between a core and a clad of a light pipe.

FIGS. 17a-17b show fragmentary, partial cross sections of light pipes having different light-extraction means.

### DETAILED DESCRIPTION OF THE INVENTION

This description describes the three areas of (1) general principles of the invention, (2) preferred geometries of light-extraction means, and (3) methods of manufacturing the geometries of the light-extraction means.

### 1. General Principles of the Invention

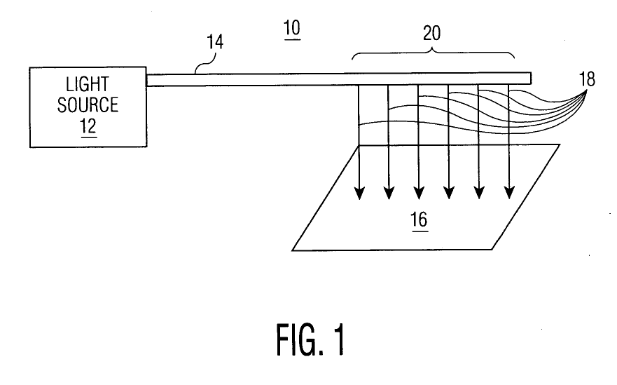

FIG. 1 shows a sidelight illumination system 10 according to the present invention. System 10 includes a light source 12, a light pipe 14, and a target surface 16 to be illuminated. Arrows 18 show directional illumination of target surface 16 from a section 20 of light pipe 14, referred to herein as the “active section.” Section 20 may comprise either a fraction of the length of light pipe 14, or the entire length of light pipe 14.

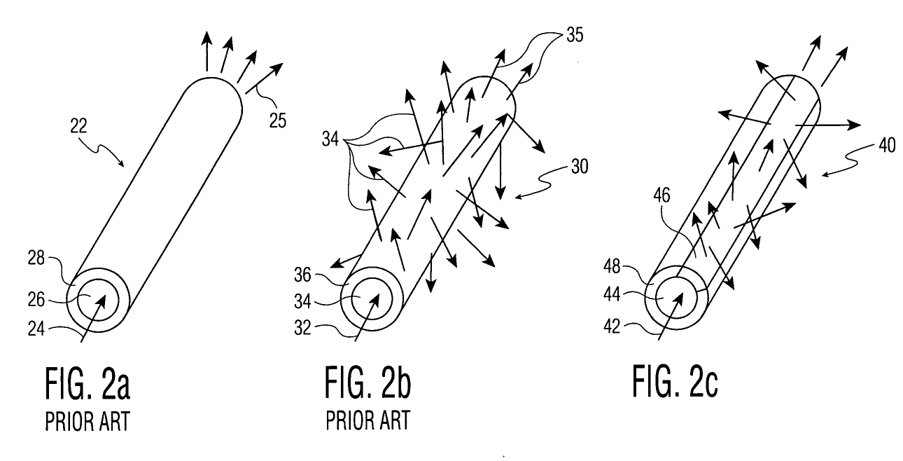

To put the sidelight illumination system of FIG. 1 into perspective, FIGS. 2a and 2b show prior art light pipes of two different types. FIG. 2a shows a prior art light pipe 22 designed to receive light 24 at one end, transport it through the light pipe with minimum attenuation, and provide illumination 25 at the other end. Light pipe 24 includes a core 26 and a cladding 28 having a lower index of refraction relative to the core.

FIG. 2b shows a length of prior art light pipe 30 constructed for sidelight emission, which is designed to extract light along its length and around its entire circumference. Thus, light 32 entering one end of light pipe 30 is extracted as sidelight 34 around the entire circumference of the light pipe. Residual light 35 passes through the other end of the light pipe. Similar to FIG. 2a, light pipe 30 has a core 32 and cladding 36.

In accordance with the invention, FIG. 2c shows one example of a light pipe 40 in which light is extracted in a manner that favors one side of the pipe. Thus, light 42 entering core 44 of the light pipe is extracted from the side of the pipe in strip-like region 46 of cladding 48. Light pipe 40 of FIG. 2c provides directional side-light extraction, and so can be used as light pipe 14 of FIG. 1.

### 2. Preferred Geometries of Light-Extraction Means

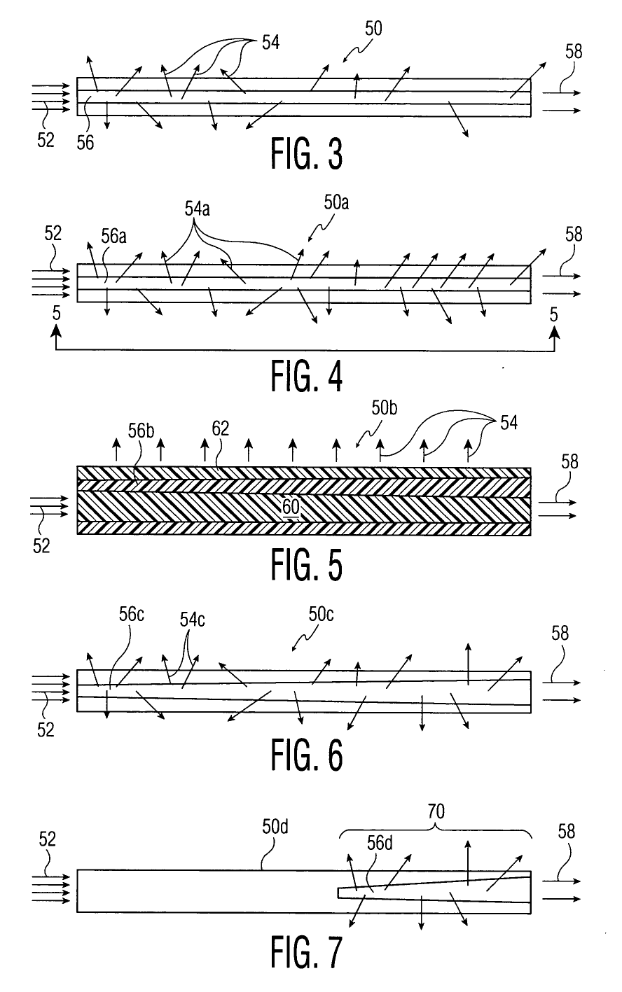

FIGS. 3-12 show preferred geometries of light-extraction means according to the invention. In all these figures, the light pipes may have a fluoropolymer cladding over a core as shown in FIG. 14a, for instance, or may be free of a fluoropolymer cladding as shown in FIG. 14b, for instance.

FIG. 3 shows an active section of a light pipe 50 that receives light 52 at one end, extracts light 54 from the side of the pipe along a strip 56 of uniform width that contains light-extraction means (described in the next section). Any light not extracted then exits the other end of the light pipe as light 58.

As can be seen in FIG. 3, a greater density of light rays 54 are extracted near input light 52 than near output light 58. This would result from having a uniform density of light-extraction means along the length of strip 56, and also from the fact that less light is available in the light pipe as the distance from input light 52 increases. To counteract this phenomenon, the light-extraction means could have a differential strength along the light pipe, with more light-extraction capability in the pipe the further away from input light 52. This phenomenon is illustrated in FIG. 4, in which extracted side-light rays 54a from light pipe 50a along strip 56a are uniform in density along the entire length of light pipe shown. As used herein, “uniformity” in side-light emission means that the lumen output as between inlet and outlet portions of a side-light emitting section of the light pipe is within plus or minus 20 percent of the average value of each other. More uniformity than this may also be desirable in some circumstances.

One way to increase the light-extraction strength along a light pipe to achieve uniform side-light extraction is shown in FIG. 5. Thus, in FIG. 5, a light pipe 50b having a core 60 and a cladding 62 includes a strip 56b of light-extraction means-such as a substrate with light-scattering material—interposed between the core and cladding. Strip 56b increases in thickness from input light 52 to output light 58. This achieves a uniform distribution of side-light 54b extracted from the light pipe. As used herein, “light-scattering material” includes material that scatters light by reflection, material that scatters light by refraction, or material that scatters light by a combination of refraction and reflection.

Rather than increasing the density of light-extraction means along the length of a light pipe—or in addition to such increase in density, FIG. 6 shows a light pipe 50c in which a strip 56c increases in width along the length of the light pipe. This increases light-extraction efficiency as the strip widens. Thus, the side-light rays 54c are uniform along the length of light pipe shown.

FIG. 7 shows a light pipe 50d having a strip 56d, whose width increases in the direction from input light 52 to output light 58. Strip 56d is similar to strip 56c of FIG. 6, although strip 56d exists only in active section 70; that is, a section of the light pipe for side-light extraction. This configuration allows the maximum amount of light to be delivered to a remote area and then be extracted through use of light-extraction means at the desired area to be illuminated.

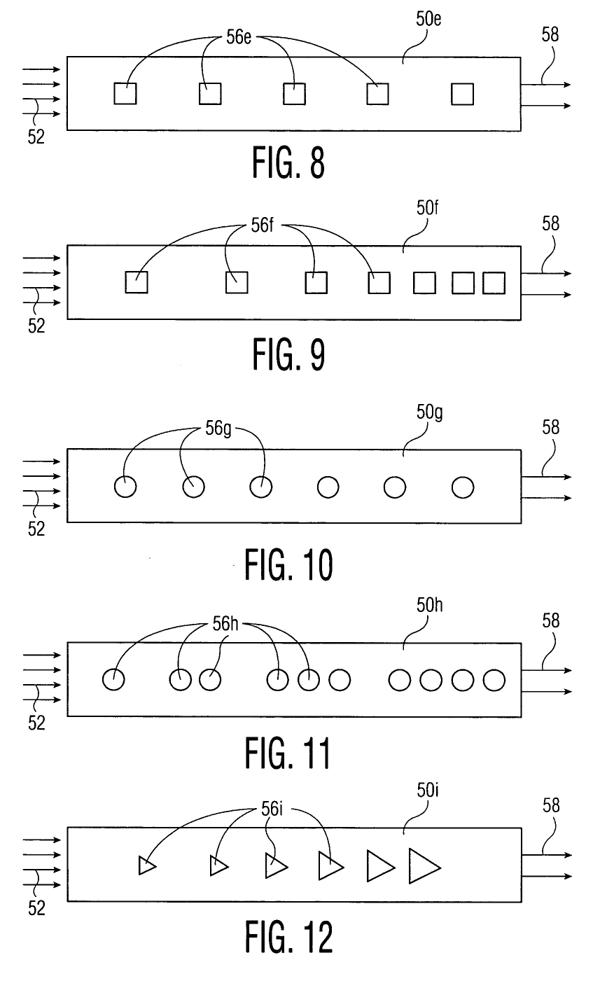

As an alternative to providing a single strip of light-extracting material 56 in FIG. 3, FIG. 8 shows a light pipe 50e in which a series of rectangular strips 56e of light-scattering means are placed along the light pipe. Using a series of constant-width strips decreases the light extraction along a section of light pipe relative to using a single strip of material with the same light-extraction strength per unit area. FIG. 9 shows a similar series of strips 56f of light-extraction means, but with a higher density the further the distance from input light 52.

Similar to FIG. 8, FIG. 10 shows round configurations of light-scattering means 56g along the length of a light pipe 50g.

Somewhat similar to FIG. 9, FIG. 11 shows round configurations of light-extraction means 56h at a higher density the further the distance from input light 52. Light-extraction means 56h, however, are bunched together in groups of differing sizes to achieve a higher density the further the distance from input light 52.

FIG. 12 shows another pattern of light-extraction means 56i for a light pipe 50i comprising a series of progressively larger triangular shapes. This illustrates that the shapes can be the same, but simply increase in size.

From the various approaches illustrated herein for achieving an increase the strength of light-extraction the further away from input light, a person of ordinary skill in the art will find combinations of various approaches to be obvious.

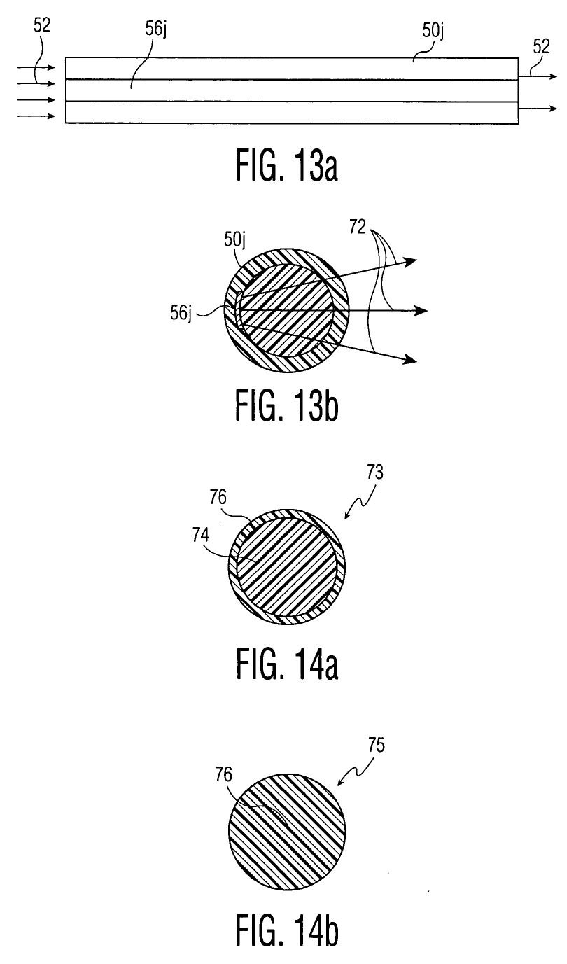

FIG. 13a shows a light pipe 50j incorporating light-extraction means 56j comprising reflective material. Suitable reflective materials include barium sulfate, titanium dioxide, calcium carbonate, zinc oxide or a metallic foil. As shown in FIG. 13b, light rays 72 are extracted from light pipe 50j by reflection from light reflective material 50j, shown greatly enlarged. This occurs when the angle of incidence of light (not shown) propagating down a light pipe and striking the reflective surface is high enough to cause the light to be extracted from the opposite side of the light pipe.

The various geometries of light-extraction means described in connection with FIGS. 3-4 and 6-12 also apply to the embodiment of FIGS. 13a-13b.

Unless otherwise noted, the various geometries of light-extraction means described in connection with FIGS. 3-13 apply to construction of a light pipes having a core with or without a fluoropolymer clad. Thus, FIG. 14a shows a light pipe 73 having a core 74 and fluoropolymer clad 76, while FIG. 14b shows a light pipe 75 having a core 76 but no fluoropolymer clad. Whether to include a fluoropolymer clad or not depends on the composition of the core and the type of light-extraction means used, which means are discussed under point (3) below.

To summarize some of the foregoing considerations under this point (2) on preferred geometries of light-scattering means—without referring to the drawings—by applying a strip of light-scattering material along one side of a light pipe, light can be extracted where the material is located in a directed manner. A uniform piece of constant width and thickness would be the easiest to manufacture. However, over a long length of light pipe, such construction would be difficult to achieve even illumination along the length of the light pipe.

As the distance along a light pipe from the light input increases, there is less and less light available for extraction. However, by making the light-extraction efficiency in the light pipe increasingly higher, the further the distance from the light input, the number of raw (i.e., non-adjusted) lumens per unit length extracted from the side of the light pipe remains substantially constant along the length and produces uniform illumination. One way to increase light-extraction efficiency is by tapering a strip containing light-scattering material, so that at increasing distances from the light input, the strip increasingly widens to increase its extraction efficiency. Alternate methods of achieving increased extraction efficiency are to vary the density of light-scattering material present within the strip, or to vary the thickness of the strip. A combination of all three of the foregoing approaches may provide the optimum design for a particular application.

This light scattering strip does not need to cover the entire length of the light pipe. If made from a longer piece of light pipe, the first section can be optimized to transmit light, such as end-light, and then the scattering material could be placed so that it extracts light at the far end of the light pipe. This would produce an integrated light pipe with a section of light pipe optimized to transport light, and a section optimized to extract light towards a target area. Several pieces of the light-scattering material could be placed along the length of a light pipe to produce more than one area of side illumination along the length of a long light pipe.

It some cases a single run of light-scattering material may extract too much light too quickly or in an undesirable distribution. To avoid this, multiple smaller pieces of light scattering strips may be applied in various patterns to produce the desired output distributions.

These light-scattering materials could be applied to many various types of light pipes.

### 3. Methods of Manufacturing the Above-Described Geometries

Light-extraction means of the invention include (i) material inserted between the core and clad of a light pipe, (ii) surfaces of the core of a light pipe treated to have light-scattering properties.

As to (i) material inserted between the core and clad of a light pipe, co-extrusion die 80 of FIG. 15 could be used. FIG. 15 shows a reservoir 82 for material for a clad 84 of a light pipe 86, but omits a reservoir for a core 87 for simplicity. A nozzle for core 87 is shown at 87a. Clad 84 is shown partially cutaway. In a molten state, the clad is shown at 85, shown partially cutaway. At this point, molten clad 85 has just been injected from a nozzle 85a. A strip 88 of material which may include regions 90 of light-extraction means, such as light-scattering material, is inserted between core 87 and clad 84 in a co-extrusion process. Alternatively, strip 88 could comprise reflective material for the embodiment described above in connection with FIGS. 13a and 13b.

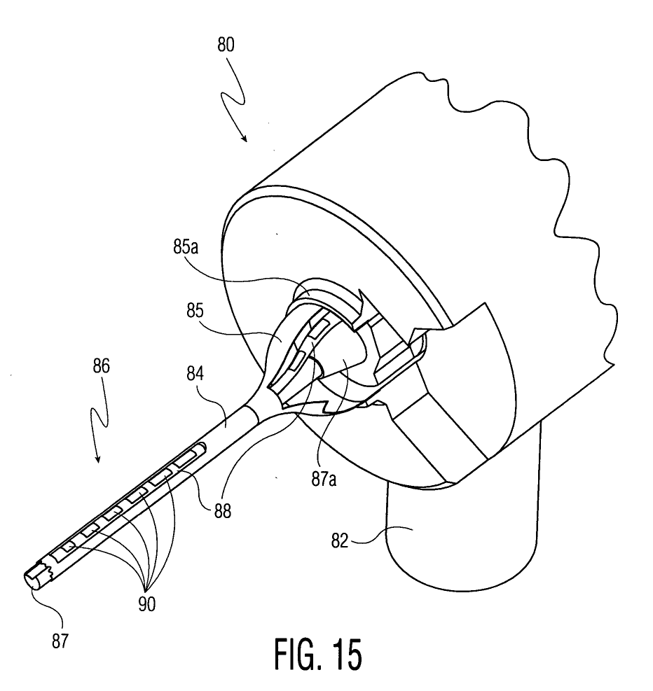

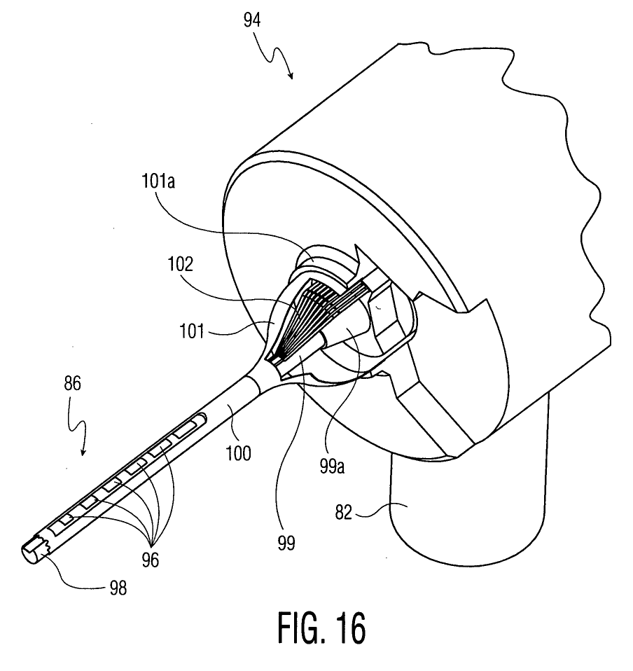

FIG. 16 shows a co-extrusion die 94 for extruding light-extracting material 96 between a core 98 and clad 100. In a molten state, the clad is shown at 101, and is partially cutaway. At this point, molten clad 101 has just been injected from a nozzle 101a, and molten core material 99 for forming core 98 has just been injected from a nozzle 99a. FIG. 16 shows a reservoir 82 for material for clad 100, but omits a reservoir for core 98 for simplicity. Multiple streams 102 of material form light-extracting material 96, which streams can be analogized to the operation of an ink-jet printer. Material 96 may comprise, as shown, a series of strips of material whose length—and hence density and light-extraction effectiveness-vary along the length of the light pipe. More generally, the light-extracting material 96 could be co-extruded in the desired shape, size, thickness, and/or density between the core and cladding material.

Two alternatives for extruding light-scattering material between the cladding and core are, first, that light-scattering material may be extruded as part of the cladding material. This can be done using multiple streams (not shown) of clad material, similar to the multiple streams of light-extracting material 102 in FIG. 16. In this case co-extrusion of the core material is not necessarily needed, as the cladding and sheathing could be extruded as a hollow tube with the desired pattern of scattering material in the cladding already. The core material could then be poured into the tube and the light pipe would be cast in the traditional manner. Second, a strip or strips of material (not shown), similar to strip 88 shown in FIG. 15, with regions 90 of light-scattering means, could be inserted into a preformed cladding in tubular form.

For light pipes which do not have a cladding, light-scattering material can be applied in the proper size and shape with a simple adhesive sticker (not shown) that is adhered to the light pipe. Alternatively, the light pipe's surface could be etched (i.e., roughened) by mechanical or chemical means, or even painted to produce the desired pattern in the surface of the light pipe. Further, organic solvents in oil-based paints can chemically etch the surface of a polymer light pipe to create light scattering, in addition to any light-scattering properties of the paint itself.

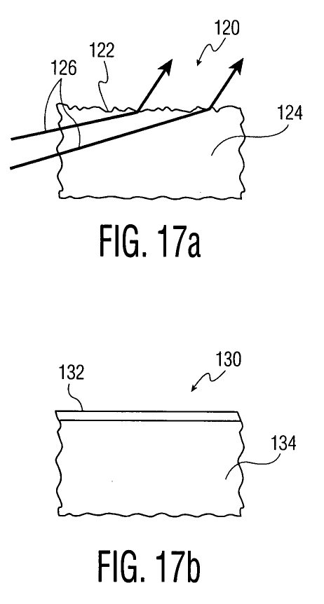

Finally, FIGS. 17a-17b show some of the different types of light-extraction means discussed in this specification.

FIG. 17a shows a light pipe 120 with an etched, or roughened, surface 122 of a core 124. Light rays 126 reaching roughened surface 122 are extracted from the side of the light pipe.

FIG. 17b shows a light pipe 130 with a paint layer 132 on a core 134. Paint layer 132 contains light-scattering material, such as titanium dioxide or barium sulfate.

While the invention has been described with respect to specific embodiments by way of illustration, many modifications and changes will occur to those of ordinary skill in the art. It is, therefore, to be understood that the appended claims are intended to cover all such modifications and changes as fall within the true scope and spirit of the invention.

What is claimed is:

1. A light pipe with directional side-light extraction, comprising:
a) a light pipe;
b) light-extraction means applied to the light pipe over only a part of the cross-sectional perimeter of the light pipe and over an active section in which directional side lighting is desired;
c) the light-extraction means comprising any of (i) material, other than a light-carrying portion of the light pipe or any fluoropolymer cladding on the light-carrying portion, including light-scattering material, (ii) surfaces treated to have light-scattering properties, and (iii) material with a reflective property.

2. The light pipe of claim 1, wherein the active section comprises a fraction of the length of the light pipe.

3. The light pipe of claim 1, wherein the light pipe has a substantially circular cross section.

4. The light pipe of claim 1, wherein the lumen output as between inlet and outlet portions of the active section is within plus or minus 10 percent of the average value of each other

5. The light pipe of claim 1, wherein the light-extraction means is a single strip of uniform width over the active section of the light pipe.

6. The light pipe of claim 1, wherein the light-extraction means is in the form of a single strip that varies in width over the active section of the light pipe

7. The light pipe of claim 1, wherein the light-extraction means is a strip that varies in thickness over the active section of the light pipe.

8. The light pipe of claim 1, wherein the light-extraction means is a single strip of material containing light-scattering additives whose density varies over the active section of the light pipe.

9. The light pipe of claim 1, wherein the light-extraction means comprises a plurality of separate shaped pieces arranged along the active section of the light pipe

10. The light pipe of claim 9, wherein the pieces are sized, composed and arranged in such a manner as to achieve a substantially uniform distribution of light from the side of the light pipe.

11. The light pipe of claim 10, wherein the pieces are arranged in a non-uniform manner.

12. The light pipe of claim 10, wherein the sizes of the pieces vary along the active section of the light pipe.

13. The light pipe of claim 4, 5, 6, 7, 8, 9 or 11, wherein:
a) the light pipe comprises a polymer core; and
b) the light-extraction means is formed from etching of the surface of the polymer core.

14. The light pipe of claim 4, 5, 6, 7, 8, 9 or 11, wherein:
a) the light pipe comprises a polymer core and a fluoropolymer cladding; and
b) the light-extraction means comprises a material inserted between the core and the cladding.

15. The light pipe of claim 14, wherein the material inserted between the core and the cladding comprises a light-scattering coating.

16. The light pipe of claim 14, wherein:
a) the core comprises an acrylic polymer; and
b) the material inserted between the core and the cladding comprises an organic-solvent based paint.

17. The light pipe of claim 16, wherein the paint is applied in discrete areas along the light pipe, with the discrete areas being spaced along the light pipe with a higher density the further the distance along the light pipe from an input light source.

18. The light pipe of claim 4, 5, 6, 7, 8, 9 or 11, wherein:
a) the light pipe comprises a polymer core which is free of a fluoropolymer cladding in the active section of the light pipe; and
b) the light-extraction means is formed from etching of the surface of the polymer core or a coating on the core.

19. The light pipe of claim 18, wherein the polymer core comprises an acrylic polymer.

20. The light pipe of claim 1, wherein a substantial section of the light pipe is free of light-extraction means so as to act as a conveyance of light between a light source and a section of the light pipe with light-extraction means.

21. The light pipe of claim 4, 5, 6, 7, 8, 9 or 11, wherein:
a) the light pipe comprise a polymer core; and
b) the light-extraction means comprises reflective material.

22. The light pipe of claim 21, wherein the light pipe comprises a fluoropolymer cladding over the core.

23. The light pipe of claim 21, wherein the light pipe is free of a fluoropolymer cladding over the core.
